(19) United States
(12) Patent Application Publication
(10) Pub. No.: US 2018/0311685 A1
(43) Pub. Date: Nov. 1, 2018

(54) METHOD FOR APPLYING A PROTECTIVE COATING BY SPRAYING AND CORRESPONDING INSTALLATION

(71) Applicant: Safran Aircraft Engines, Paris (FR)

(72) Inventor: Sebastien Philippe Maurice Bertin, Moissy-Cramayel (FR)

(73) Assignee: Safran Aircraft Engines, Paris (FR)

(21) Appl. No.: 15/963,382

(22) Filed: Apr. 26, 2018

(30) Foreign Application Priority Data
Apr. 28, 2017 (FR) 1753753

(51) Int. Cl. B05B 1/28; B05D 1/02

(52) U.S. Cl. CPC B05B 1/28; B05D 1/02

(57) ABSTRACT

A method of applying a protective coating by spraying onto annular protuberances of a component includes at least one first element and an annular portion bearing the protuberances extending axially from a side wall of the first element, wherein a first protuberance is arranged axially closest to the first element and bears a face opposite to the first element, wherein the method has the following stages:
arranging reflection means axially between said side wall of the first element and the first annular protuberance, and
spraying, via the spraying means, a spray of a protective material towards the reflection means such that the spray of protection impacts the face, opposite to the first element, of the first protuberance.

### CROSS-REFERENCE TO RELATED APPLICATIONS

This application claims the benefit of French Patent Application No. 1753753, filed Apr. 28, 2017, the contents of which are incorporated herein by reference.

### TECHNICAL FIELD

The present invention relates to a method for applying a protective coating by spraying onto annular lips of a turbine engine drum in addition to the corresponding installation.

### BACKGROUND

Axisymmetric turbine engine drums are generally tubular-shaped elements comprising an axial succession of discs connected to each other by annular shrouds bearing lips extending radially outwards. Each disc comprises a plurality of cavities for holding the blade roots, said cavities having a substantially dovetailed or fir-tree-shaped profile.

The term radial is conventionally understood to be perpendicular to the longitudinal axis of the turbine engine, the axis along which the gases flow into the turbine engine.

The lips have an isosceles trapezoid shape, with the top of the lip corresponding to the smaller base of the trapezoid. Generally, these lips extend over a short radial distance and their radially external ends are located radially below the outer surfaces of the cavities.

In order to avoid the lips being damaged during operation by the high temperatures, it is required to cover them, at least partially, with a thermal protective coating. This thermal coating allows in particular abrasion of an abradable material installed opposite to the top of the lips, without excessive deterioration of the lips as a result of the friction. The trench created in the abradable material forms in this case, together with the lips, a fluid-tight bearing. The protective coating is applied to the upstream and downstream faces of the lips as well as to the top of the lips by thermal spraying.

The terms upstream and downstream refer to the direction of gas flow into the turbine engine.

The thermal spraying generates a jet or spray of semi-fused material. This spraying is performed using spraying means comprising a torch, the axis of which is inclined in relation to the drum axis, wherein the torch follows a linear path allowing coating of the lips of a same stage. The areas of the drum that are not to be coated are protected by specific masking, in particular due to the small dimensions of the lips, compared to the diameter of the spray of semi-fused material.

In order to ensure optimum spraying of the spray of protective material, parameters such as a given inclination of the spray of protective material and a given speed of movement of the spraying means in relation to the drum axis and a given distance in relation to the drum, need to be observed. A material flow rate is determined by combining these initial parameters. The distance of the spraying means in relation to the drum is particularly explained by the large overall dimensions of the spraying means.

These parameters however, particularly the necessary inclination of the spray of protective material, do not allow spraying of the protective material onto the upstream face of the lip closest to the disc. Indeed, the disc, due to its radial extension beyond the radially external ends of the lips, forms an obstacle to spraying of the protective material.

Thus, when the spraying means are moved axially from the upstream disc towards the downstream disc, the spray of material is able to reach the upstream face of some lips, but not that of the lip closest to the upstream disc.

To overcome this problem, a first obvious solution could involve adjusting the angle of inclination of the spraying means. As a result of this change in angle however, the coat of protective material does not structurally comply with the technical validation specifications. Indeed, by reducing the spraying spray angle, i.e. by increasing its perpendicularity to the drum axis, the first face of the first lip is reached by the spray, but the coat obtained does not have a suitable structure. A coat of protective material is considered not to have a suitable structure when it is too thin or too thick, for example, or when its thickness is inconsistent. In order to obtain a satisfactory result with a smaller angle, it would subsequently be necessary to change the operating parameters of the spraying means (flow rate, speed of movement . . . ), which is not possible however due to the close interdependence of the latter.

A second solution aiming to reduce the speed of movement of the spraying means has also been proposed. This solution is not acceptable however, if the coat of protective material sprayed onto the first face of the lip closest to the upstream disc would comply with specifications, the coat of protective material sprayed onto the first face of the other lips would not comply with specifications, particularly since its thickness would be excessive and its structure would therefore not be suitable. Indeed, reducing the speed of movement of the spraying means allows the entire first face of the first lip to be completely coated with the protective material before the spray impacts the disc, particularly through the effect of gravity of the protective material which flows along the first face of the first lip, towards the drum. As regards the other lips, reducing the speed will result in an excessive amount of protective material being applied to the first face, with the coats thus applied not having a suitable structure in this case.

It should be noted that changing any of the aforementioned operating parameters (flow rate, speed of movement) of the spraying means results in a change in the other parameters and leads to deviation from the technical validation specifications for producing the protective coat. The component sprayed with the protective material cannot in this case be considered compliant; it is therefore desirable to retain the operating parameters of the spraying means.

### SUMMARY

The invention more particularly aims at providing a simple, efficient and cost-effective solution to this problem.

For this purpose, it provides for a method of applying a protective coating by spraying onto annular protuberances of a component comprising at least one first annular element and an annular portion bearing the protuberances extending axially from a side wall of the first element, wherein a first protuberance is arranged axially closest to the first element and bears a face opposite to the disc, characterised in that it comprises the following stages:
a) arranging reflection means axially on the component between said side wall of the first element and the first annular protuberance,
b) spraying, via spraying means, a spray of a protective material towards the reflection means such that the spray of protection impacts the face opposite to the first element of the first protuberance that is opposite to the first element.

The reflection means allow, when the material is sprayed on the second face of the protuberances, the spray of protective material to be deflected towards the first face of the protuberance closest to the first upstream element. Hence, with an optimum inclination, it is possible to cover with a coat of protective material all the second faces of the protuberances and the first face of the protuberance closest to the first element in the same spraying pass, followed by the first face of the other protuberances in a second spraying pass.

During stage b) the spraying direction of the spray of material is able to form an angle of between 0 and 25° with a radial plane intercepting said direction at the point of impact of the spray on the reflection means, with a nozzle outlet of the material spraying means being located opposite to the disc in relation to said radial plane. For this purpose, the nozzle is positioned such that the spraying direction of the spray of material forms an angle α of between 0 and 25° with a radial plane intercepting said direction at the point of impact of the spray on the reflection means. This angle α is measured when the outlet of the material spraying means is situated opposite to the disc in relation to said radial plane.

This angle of inclination enables the sprayed spray to exhibit the characteristics required for achieving a spraying that complies with specifications while limiting the area coated by the protective material in the area of the protuberances.

The method can comprise a stage involving axial movement of the spraying means, in a first direction oriented from the protuberances towards the first element, such that the spray of material reaches all the protuberances and the reflection means.

The movement makes it possible to coat the second face of each of the protuberances and the first face of the protuberance closest to the first upstream element.

The method can also comprise a stage involving reorienting the spraying means, by symmetry in relation to a transversal plane perpendicular to the axis of the component and moving said means axially, in a second direction, opposite to the first direction.

Reorienting the spraying means makes it possible to coat the first face of the protuberances other than that closest to the first upstream element, already coated when the second face of the protuberances is coated.

The method can furthermore comprise a stage involving removing the reflection means from the component.

Following removal of the reflection means, the component can subsequently be mounted on the turbine engine.

The reflection means can comprise a ring made of polymeric material, particularly silicone, having a hardness of between 35 and 65 Shore.

The specific Shore A hardness of between 35 and 65, preferentially of 50, makes it possible to control the spray of protective material. Thus, the chosen hardness ensures that the spray of protective material bounces on the reflection means towards the first face of the protuberances.

The ring can be a split ring, elastically deformable so as to be mounted tightly around the annular portion.

The slit in the ring allows its elastic deformation to facilitate its positioning on the annular portion, between the first upstream element and the protuberance closest to the first element.

A radially external end of the side wall of the first element can be located radially outside a radially external end of the protuberances.

The face and side wall can be annular.

The component can be a turbine engine drum, the first element can be a disc of the drum, the annular portion can be a shroud of the drum and the annular protuberances can be annular lips.

The annular portion can comprise a substantially cylindrical wall on which a cylindrical wall of the ring is tightly mounted.

The annular portion can comprise a radial wall in axial abutment against the side wall of the first element.

The invention also provides an assembly comprising a component featuring at least one first element and an annular portion bearing protuberances and the annular portion extending axially from the side wall of said first element, spraying means for a spray of protective material arranged radially outside the component, characterised in that the assembly also comprises reflection means for said spray of spraying material, wherein the reflection means are an elastically deformable ring tightly mounted around the annular portion arranged axially between said downstream side wall of the first element disc and the first annular protuberance, wherein the reflection means are capable of reflecting the spray of material towards the face opposite to the first element of the first protuberance, wherein the first reflection means are for example an elastically deformable ring tightly mounted around the annular portion.

An assembly of this kind allows implementation of the aforementioned method, in order to coat both the first face and second face of each of the protuberances in compliance with specifications.

### BRIEF DESCRIPTION OF THE DRAWINGS

The invention will be better understood, and other details, characteristics and advantages of the invention will appear upon reading the following description given by way of a non-restrictive example while referring to the appended drawings wherein:

FIG. 1 is a detailed view of the lips of a turbine engine drum;

FIG. 2 is a detailed view of an installation for applying a protective coating by spraying onto annular lips of the drum in FIG. 1;

FIG. 3 is a schematic view showing a nozzle for spraying the protective material onto the lips of the drum;

FIG. 4 is a sectional view of the reflection means of the installation in FIG. 2 and

FIGS. 5 and 6 are detailed views of the drum in FIG. 1 on which the reflection means for a spray of material are mounted, illustrating the movement of the spraying means in two opposite directions.

### DETAILED DESCRIPTION

Conventionally, the terms “radial” and “axial” refer to a longitudinal axis A of the turbine engine.

Likewise, the terms “upstream” and “downstream” refer to the direction of flow of the gases G into the turbine engine.

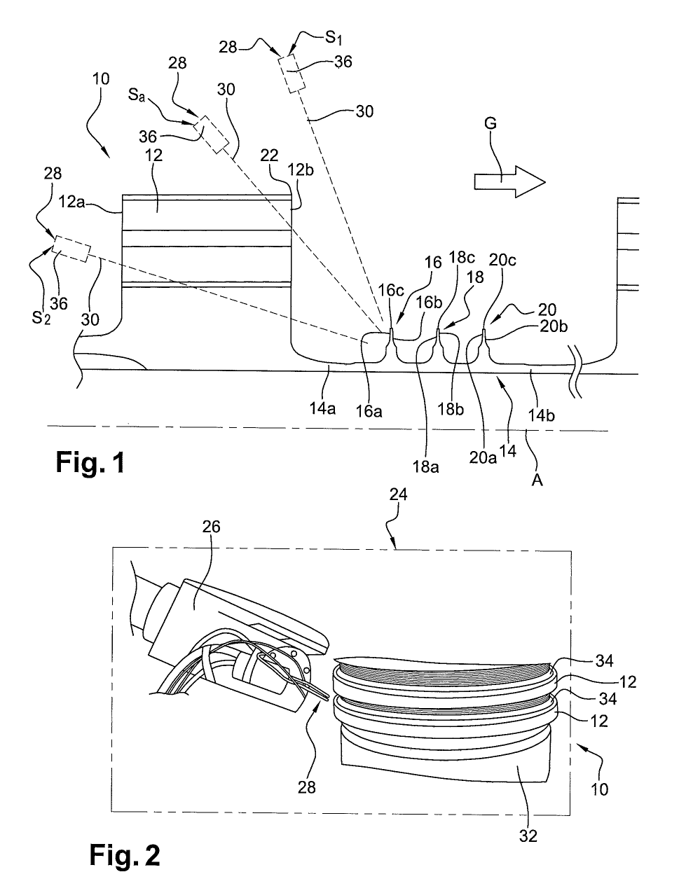

The detail of a component is illustrated in FIG. 1, in the present case a turbine engine drum 10. The drum 10 comprises at least one first element 12, in the present case a disc, at least one annular portion 14, in the present case an annular shroud and protuberances 16, 18 and 20, in the present case annular lips.

The invention is however applicable to any turbine engine component comprising at least one first annular element, at least one annular portion and annular protuberances projecting from the annular portion.

The drum 10 comprises an axial succession, i.e. extending along the axis A of the drum 10, of discs 12 between which the annular shrouds 14 bearing the annular lips 16,18, 20 are interposed, which themselves extend radially from the annular shroud 14. It can therefore be seen that the lips 16,18, 20, on a drum 10 as illustrated, are axially interposed between a portion of the upstream shroud 14 and portion of the downstream shroud. FIG. 1 only represents a complete disc 12 and a shroud 14 bearing three lips 16, 18, 20, with the disc 12 being positioned in this case upstream from the lips 16, 18, 20.

The disc 12 features an upstream side wall 12a and a downstream side wall 12b, with the downstream side wall 12b being opposite to the lips 16, 18, 20. Furthermore, the disc 12 features a radially external end 22 of the downstream side wall 12b, located radially outside a radially external end 16c, 18c, 20c of the lips 16, 18, 20.

As illustrated, the drum 10 comprises a first lip 16, a second lip 18 and a third lip 20, with the first lip 16 being arranged axially closest to the disc 12 illustrated on the left in FIG. 1.

The lips 16, 18, 20 are formed, on the shroud 14, of small projections, whereby these projections can be integrally formed with the shroud 14 or added to the shroud 14.

Each lip 16, 18, 20 has a substantially trapezoidal section that comprises a first face 16a, 18a, 20a turned towards the upstream disc 12 and a second opposite face 16b, 18b, 20b, i.e. turned towards a downstream disc (partially illustrated). As can be seen in FIG. 1, the lips 16, 18, 20 therefore extend over a short radial distance in relation to the disc 12. The lips 16, 18, 20 are for example made of Ti17 or Tl 6.2.4.2. Furthermore, each lip 16, 18, 20 comprises at its top, opposite to the shroud 14, a third face 16c, 18c, 20c, connecting the first face 16a,18a, 20a to the second face 16b, 18b, 20b.

In order to ensure their resistance, particularly to heat, the lips 16, 18, 20 are covered with at least one coat of a protective material such as for example a material with the following composition: type II 97-3% w Al₂O₃—TiO₂.

Advantageously, an undercoat can be applied prior to the coat of protective material, wherein this undercoat is for example a material with the following composition: type II 95-5% w Ni—Al.

Coating of the lips 16, 18, 20 is performed by an installation 24 for applying a protective coating, which is illustrated in detail in FIG. 2.

This installation 24 comprises an arm 26 bearing spraying means 28 for a spray 30 of protective material, a support on which the drum 10 is positioned and reflection means 34 for the spray 30.

The arm 26 is for example of the mechanical articulated arm type well known in the industry and will therefore not be described in further detail. It should be noted however that due to its dimensions, the arm 26 is bulky in relation to the drum 10 and the lips 16, 18, 20.

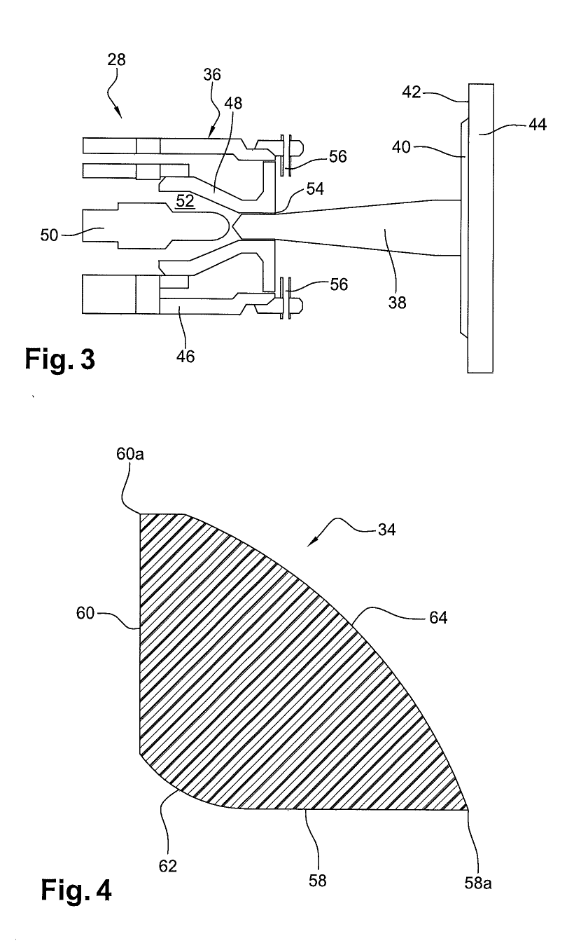

The spraying means 28 for the spray 30 of protective material are arranged radially outside the drum and comprise a spraying nozzle 36 (FIGS. 1 and 3), such as a plasma nozzle for example, represented diagrammatically in FIG. 3.

The nozzle 26, in action of spraying a spray 38 of material forming a coating layer 40 on the surface 42 of a component 44, comprises a casing 46 in which an anode 48 and a cathode 50 are received coaxially from the outside inwards. The anode 48 and the cathode 50 jointly form an annular passage 52 for a plasma gas intended to be ejected from the nozzle 36, in the direction of the component 44, via an outlet 54 of the nozzle 36.

The casing 46 bears two injectors of powder 56, for example powders capable of forming, with the plasma gas, the aforementioned materials of the coat and the undercoat, with these injectors emerging towards the outlet 54 of the nozzle 36.

The support 32 (FIG. 2) adopts the form of a column inserted into the drum 10, concentrically in relation to the shrouds 14. The support 32 furthermore comprises stops (not illustrated) against which the drum 10 rests so as to be held in a predetermined position allowing spraying of the spray 30 of protective material on to the lips 16, 18, 20.

The reflection means 34 comprise a ring made of polymeric material, particularly silicone, having a Shore A hardness of between 35 and 65. This ring is split and elastically deformable so as to be tightly mounted around the shroud 14 as will be seen below.

When viewed in longitudinal section, as shown in FIG. 4, the ring has a substantially quarter disc shape. The quarter disc shape comprises a base or wall 58 forming a cylindrical surface and an upright or radial wall 60 substantially perpendicular to the base or wall 58 and forming an annular surface. The cylindrical wall 58 is in abutment radially towards the inside of the radially external surface of the annular portion 14. The radial wall 60 is in axial abutment on the downstream side wall 12b of the first element 12. The junction between the base and the upright is formed by a fillet 62 and the free ends 58a, 60a of the base and the upright are connected to each other by a convex reflection surface 64.

In variants not illustrated in the figures, the free ends 58a, 60a of the base 58 and of the upright 60 could be connected to each other by a concave reflection surface, a flat surface or a combination of concave, convex and/or flat surfaces.

The installation 24 can also comprise one (or several) mask(s) 66 (visible in FIG. 6) positioned on the disc 12 so as to protect the upstream side wall 12a and/or the downstream side wall 12b against the spray 30 of protective material. This mask 66 can also be made of silicone, which allows its easy installation on and removal from the disc 12. The function of the reflection surface will be described later.

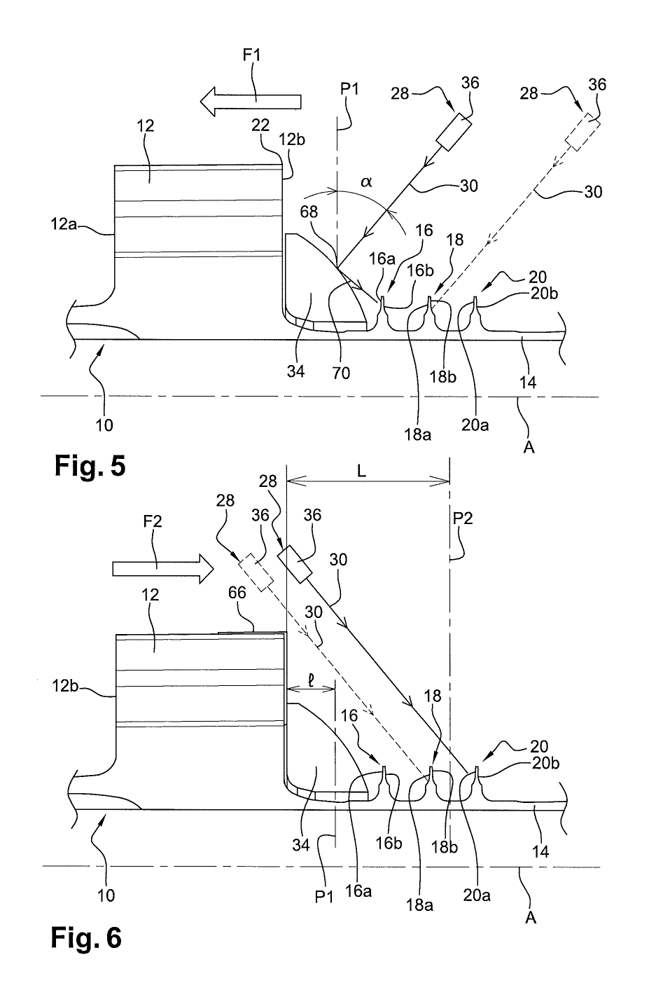

Reference is now made to FIGS. 5 and 6 which illustrate two stages of a process of applying a protective coating by spraying onto the lips 16, 18, 20 of the drum 10.

This method comprises the steps consisting of:
a) applying the reflection means 34, by elastic deformation, axially between said downstream side wall 12b of the disc 12 and of the first lip 16 and
b) spraying, via the spraying means 28, a spray 30 of a protective material towards the reflection means 34 such that the spray of protection 30 impacts the first face 16a, opposite to the disc 12, of the first lip 16.

More precisely, the spray 30 impacting the convex reflection surface 64 of the reflection means 34 is furthermore deflected towards the first face 16a of the first lip 16.

Unlike the solutions of the prior art illustrated in Sa, S1 and S2 in FIG. 1, the first face 16a of the first lip 16 can be coated with protective material so as to meet technical specifications. Indeed, with the former solution Sa, in which the spray 30 retains its orientation, covering the first face 16a, 18a, 20a of each of the lips 16, 18, 20, it is observed that the trajectory of the spray 30 encounters an obstacle comprising the disc 12 and cannot reach the first surface 16a of the first lip 16.

The first solution S1 initially envisaged shows that if the orientation of the spraying means 28 is changed to allow coating of the first face 16a of the first lip, without the disc 12 forming an obstacle, the distance of the spraying means 28 in relation to the axis A of the drum 10 must be modified and that the spray 30 is concentrated at a point on the surface, preventing the coat from being structurally compliant with technical specifications.

As an alternative to the first solution S1, a solution S2 is illustrated, again in FIG. 1, in which orientation of the spraying means 28 is more tangential to the axis A of the drum 10. Such a change in orientation however only increases the problem of the former solution Sa in that the disc 12 forms a greater obstacle than in Sa. Furthermore, the distance of the spraying means 28 in relation to the axis A is substantially changed contrary to technical specifications.

The orientation of the spraying means 28 for spraying the spray 30 of protective material and more specifically the orientation of the outlet 54 of the nozzle 36 is therefore important.

In order to determine this orientation, the nozzle 36 is positioned such that the spraying direction of the spray 30 of material forms an angle α of between 0 and 25° with a radial plane P1 intercepting said direction at the point of impact 68 of the spray on the reflection means 34. This angle α is measured when the outlet 54 of the material spraying means 34 is situated opposite to the disc 12 in relation to said radial plane P1.

Since the thickness of the spray 30 is defined according to a specific protocol, the spraying means 34 need to be moved axially so that the spraying means 34 are able to spray the material on to all the lips 16, 18, 20.

Thus, in another stage of the process, the spraying means are moved axially, in a first direction oriented from the lips 16, 18, 20 towards the disc 12 arranged upstream, wherein this first direction of movement is represented by the arrow F1 in FIG. 5. According to this first direction of movement, the spray 30 of material is then able to reach the second face 16b, 18b, 20b of all the lips 16, 18, 20 as well as the first face 16a of the first lip 16 by rebound 70 on the convex reflection surface 64 of the reflection means 34.

In FIG. 5, the movement, in a first direction, of the spraying means 28 and therefore of the spray 30 is again materialised by the presence in dotted lines of an intermediate position of these means before a near-final position in solid lines.

Still in another stage following movement of the spraying means in a first direction, the spraying means 28 are reoriented, by symmetry in relation to a transverse plane P2 perpendicular to the axis A of the drum 10. P2 is situated at an axial distance L of the upstream disc 12 greater than the axial distance I between P1 and the upstream disc 12. Furthermore, P2 is substantially parallel to P1.

When the spraying means 28 are reoriented, they are moved axially, in a second direction, opposite to the first direction, with this second direction of movement being represented by the arrow F2 in FIG. 6. According to this second direction of movement, the spray 30 of material is then able to reach the first face 18a, 20a of the second lip 18 and of the third lip 20.

It should be noted that there is no need to dismantle the reflection means 34 from the component 10.

In FIG. 6, the movement, in a second direction, of the spraying means 28 and therefore of the spray 30 is again materialised by the presence in dotted lines of an intermediate position of these means before a near-final position in solid lines.

When the first face 16a, 18a, 20a and the second face 16b, 18b, 20b of each lip 16, 18, 20 are coated with protective material, the reflection means 34 can be removed during a last stage.

The method and the installation described therefore allow production of a coating, complying with technical specifications, of the first face 16a, 18a, 20a and the second face 16b, 18b, 20b of each lip 16, 18, 20.

Furthermore, the first direction F1 and the second direction F2 of movement can be reversed.

1. A Method of applying a protective coating by spraying onto annular protuberances of a component comprising at least one first annular element and an annular part bearing the annular protuberances extending axially from a side wall of the first annular element, wherein a first annular protuberance is arranged axially closest to the first annular element and bears a face opposite to the first annular element, wherein the method comprises the following stages:
a) applying reflection means axially on the component between said side wall of the first annular element and the first annular protuberance, wherein the reflection means comprise an elastically deformable ring tightly mounted around an annular portion, and
b) spraying, via spraying means, a spray of a protective material towards the reflection means such that the protective spray impacts the face of the first annular protuberance that is opposite to the first annular element.

2. The method according to claim 1, wherein during stage b), a spraying direction of the spray of the protective material forms an angle (a) of between 0 and 25 degrees with a radial plane intercepting said direction at a point of impact of the spray on the reflection means, with a nozzle outlet of the spraying means being located opposite to a disc in relation to said radial plane.

3. The method according to claim 2, comprising a stage involving axial movement of the spraying means, in a first direction oriented from the annular protuberances towards the first annular element, such that the spray of the protective material reaches all the annular protuberances and the reflection means.

4. The method according to claim 3, comprising a stage involving reorienting the spraying means, by symmetry in relation to a transversal plane perpendicular to an axis of the component and moving said spraying means axially, in a second direction, opposite to the first direction.

5. The method according to claim 1, comprising a stage involving removing the reflection means from the component.

6. The method according to claim 1, wherein the elastically deformable ring is made of polymeric material having a hardness of between 35 and 65 Shore A.

7. The method according to claim 6, wherein the elastically deformable ring is a split ring.

8. The method according to claim 1, wherein one radially external end of an outer wall of the first annular element is located radially outside a radially external end of the annular protuberances.

9. The method according to claim 1, in which the face of the first annular protuberance and the side wall of the first annular element are annular.

10. The method according to claim 1, wherein the component is a turbine engine drum, the first annular element is a disc of the turbine engine drum, the annular portion is a shroud of the turbine engine drum, and the annular protuberances are annular lips.

11. The method according to claim 1, wherein the annular portion comprises a substantially cylindrical wall on which a cylindrical wall of the elastically deformable ring is tightly mounted.

12. The method according to claim 1, wherein the annular portion comprises a radial wall in axial abutment against the side wall of the first annular element.

13. An assembly comprising:
a component featuring at least one first element and an annular portion bearing protuberances and the annular portion extending axially from a side wall of said first element;
spraying means for a spray of protective material arranged radially outside the component;
reflection means for said spray of protective material, wherein the reflection means are an elastically deformable ring tightly mounted around the annular portion arranged axially between said side wall of the first element and a first annular protuberance, wherein the reflection means are capable of reflecting the spray of protective material towards a face opposite to the first element of the first protuberance, wherein the reflection means are an elastically deformable ring tightly mounted around the annular portion.

14. The method according to claim 1, wherein the elastically deformable ring is made of silicone having a hardness of between 35 and 65 Shore A.
